(19) United States
(12) Patent Application Publication
(10) Pub. No.: US 2025/0321800 A1
(43) Pub. Date: Oct. 16, 2025

(54) METHODS, SYSTEMS, ARTICLES OF MANUFACTURE, AND APPARATUS TO SCHEDULE RESOURCES FOR MODEL INFERENCE

(71) Applicants: Cong Zhang, Shanghai (CN); Yi Qian, Shanghai (CN); Wenjian Shao, Shanghai (CN); Wanglei Shen, Shanghai (CN); Zhisheng Zhou, Shanghai (CN); Guangli Zhang, Shanghai (CN)

(72) Inventors: Cong Zhang, Shanghai (CN); Yi Qian, Shanghai (CN); Wenjian Shao, Shanghai (CN); Wanglei Shen, Shanghai (CN); Zhisheng Zhou, Shanghai (CN); Guangli Zhang, Shanghai (CN)

(21) Appl. No.: 19/253,178

(22) Filed: Jun. 27, 2025

(30) Foreign Application Priority Data
Apr. 22, 2025 (WO) PCT/CN2025/090334

(51) Int. Cl. G06F 9/50

(52) U.S. Cl. CPC G06F 9/5027

(57) ABSTRACT

Systems, apparatus, articles of manufacture, and methods are disclosed to schedule resources for model inference. An example apparatus includes interface circuitry, machine-readable instructions, and programmable circuitry to be programmed by the machine-readable instructions to: generate first assignment data structures to respectively assign portions of artificial intelligence (AI) models to respective compute devices for execution, change the assignments in the assignment data structures to generate offspring data structures, change ones of the assignments in the offspring data structures, replace ones of the first assignment data structures with ones of the changed offspring data structures to generate second assignment data structures, and assign the portion of the AI models for execution by the compute devices based on the second assignment data structures.

### RELATED APPLICATION

This patent claims priority under 35 U.S.C. § 119 to International Application No. PCT/CN2025/090334, which was filed on Apr. 22, 2025. International Application No. PCT/CN2025/090334 is hereby incorporated herein by reference in its entirety.

### BACKGROUND

Artificial Intelligence (AI) models are trained, and then distributed to computational resources for inference operations to accomplish particular task objectives. The distributed AI models may be executed on a diverse combination of the computational resources, such as targeted Internet of Things (IoT) devices, consumer mobile devices (e.g., wireless telephones), laptop personal computers (PCs), and/or servers.

### BRIEF DESCRIPTION OF THE DRAWINGS

FIG. 1 is a block diagram of an example environment in which example mesh circuitry and scheduling circuitry operates to schedule resources to perform model inference operations.

FIG. 2 is a block diagram of an example implementation of the model circuitry of FIG. 1.

FIG. 3 is a block diagram of an example workflow for mesh network management.

FIG. 4 is a block diagram of an example model to be managed by the example scheduling circuitry of FIG. 1.

FIG. 5 is a block diagram of an example assignment data structure framework managed by the example scheduling circuitry of FIG. 1.

FIG. 6 is a block diagram of an example implementation of the scheduling circuitry of FIG. 1.

FIG. 7 is a block diagram of an example implementation of crossover operations.

FIG. 8 is a block diagram of an example implementation of mutation operations.

FIGS. 9-12 are flowcharts representative of example machine readable instructions and/or example operations that may be executed, instantiated, and/or performed by example programmable circuitry to implement the mesh circuitry and/or the scheduling circuitry of FIGS. 1, 2 and 6.

FIG. 13 is a block diagram of an example processing platform including programmable circuitry structured to execute, instantiate, and/or perform the example machine readable instructions and/or perform the example operations of FIGS. 9-12 to implement the mesh circuitry and/or the scheduling circuitry of FIGS. 1, 2 and 6.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine readable instructions of FIGS. 9-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Artificial Intelligence (AI) models for inference operations may be executed by one or more compute devices. Such compute devices (also referred to as computational resources) include Central Processing Units (CPUs), Graphics Processing Units (GPUs), Neural Processing Units (NPUs), accelerator circuitry, Application Specific Integrated Circuits (ASICs), Field Programmable Gate Arrays (FPGAs), etc. Compute devices may be implemented on one or more platforms, such as a single PC device or across two or more servers in a server rack. Some such platforms may perform trillions of operations per second (TOPS).

The emergence of AI models having greater size and complexity, such as transformer-based large models, is presenting a challenge for some platforms. In some examples, the size of the model exceeds the capabilities (e.g., target TOPS) of the platform, particularly when individual types of computing resources are not utilized for inference operations. Some examples disclosed herein include cross-device parallel inference techniques to run (e.g., inference) the large models (e.g., transformer-based models) across any number of distributed compute devices on the same platform, and/or one or more compute devices distributed across two or more platforms having heterogeneous computing resources. Some examples disclosed herein include a mesh topology-based parallel inference architecture to accommodate large AI models on compute devices. Some examples disclosed herein dynamically schedule resources within/on a compute device in a manner that considers combinations of the compute device with particular portions of the model. A fitness score is applied to the combined compute devices in some examples. In some examples, a “schedule” refers to an assignment of (a) a model portion to (b) one or more compute devices. In some examples a “model portion” is a part of a model, but less than the whole model. Some examples disclosed herein accommodate for dynamic changes to compute devices, such as instances when a new compute device (e.g., a new platform having one or more CPUs, GPUs, etc.) becomes available as a candidate resource to perform model inference. Alternatively, some examples disclosed herein accommodate for particular compute devices that leave and/or otherwise exit a pool of candidate resources capable of performing model inference.

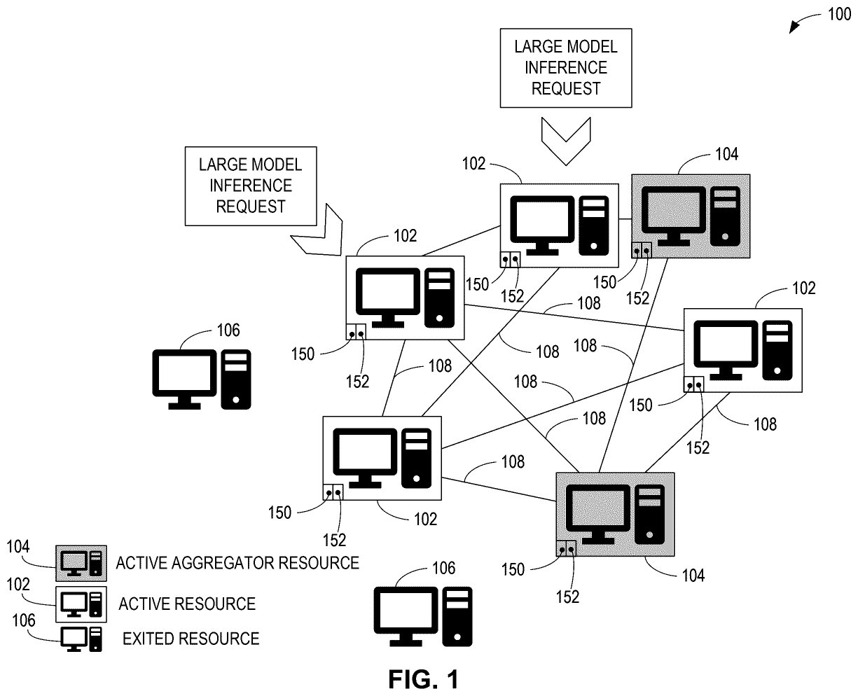

FIG. 1 is a block diagram of an example mesh environment 100 in which example mesh circuitry 150 operates to manage compute devices, and in which example scheduling circuitry 152 operates to schedule models and/or portions of the models to be run by particular ones of the compute devices. The example environment 100 of FIG. 1 includes active compute devices 102, aggregator resources 104, and exited resources 106. In some examples, compute devices (or computational resources) may be referred to as “nodes” of the mesh environment 100. Active compute devices 102 include one or more types of computational resource(s) and/or platforms thereof that are communicatively connected to one or more other active compute devices 102 and/or aggregator resources 104 via at least one communication channel 108. Example communication channels 108 include, but are not limited to busses, PCIe, and networks, such as wireless networks and/or cable-based networks.

In some examples, “aggregator resources” 104 include one or more types of computational resource(s) that are communicatively connected to one or more other active compute devices 102 and/or aggregator resources 104 with at least one communication channel 108. Example aggregator resources 104 include memory and/or storage resources to store resource lists and compute device schedules. Generally speaking, the example aggregator resources 104 may include a relatively larger memory and/or storage when compared to the example active compute devices 102.

In some examples, “exited resources” 106 include one or more types of compute devices 102 that are not communicatively connected to one or more other active compute devices 102 and/or aggregator resources 104. In some examples, the exited resources 106 include computational capabilities similar to those of the active compute devices 102 and/or aggregator resources 104, but are not currently participating in the mesh environment 100.

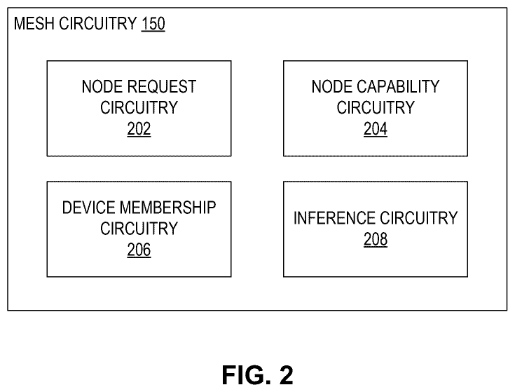

FIG. 2 is a block diagram of an example implementation of the mesh circuitry 150 of FIG. 1 to manage resources of a mesh network. The mesh circuitry 150 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the mesh circuitry 150 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The illustrated example mesh circuitry 150 of FIG. 2 includes example node request circuitry 202, example node capability circuitry 204, example device membership circuitry 206, and example inference circuitry 208.

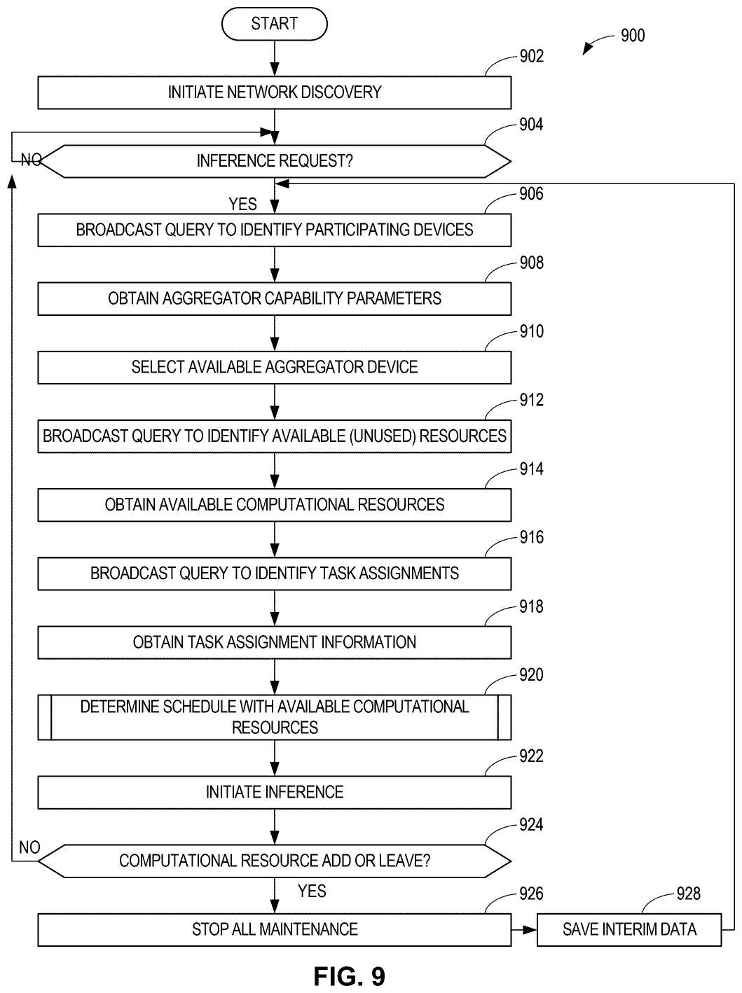

In some examples, the mesh circuitry 150 is instantiated by programmable circuitry executing mesh management instructions and/or configured to perform operations such as those represented by the flowchart(s) of FIGS. 9-12. In some examples, the node request circuitry 202 is instantiated by programmable circuitry executing node request instructions and/or configured to perform operations such as those represented by the flowchart(s) of FIGS. 9-12. In some examples, the node capability circuitry 204 is instantiated by programmable circuitry executing capability determination instructions and/or configured to perform operations such as those represented by the flowchart(s) of FIGS. 9-12. In some examples, the device membership circuitry 206 is instantiated by programmable circuitry executing membership determination instructions and/or configured to perform operations such as those represented by the flowchart(s) of FIGS. 9-12. In some examples, the inference circuitry 208 is instantiated by programmable circuitry executing inference instructions and/or configured to perform operations such as those represented by the flowchart(s) of FIGS. 9-12.

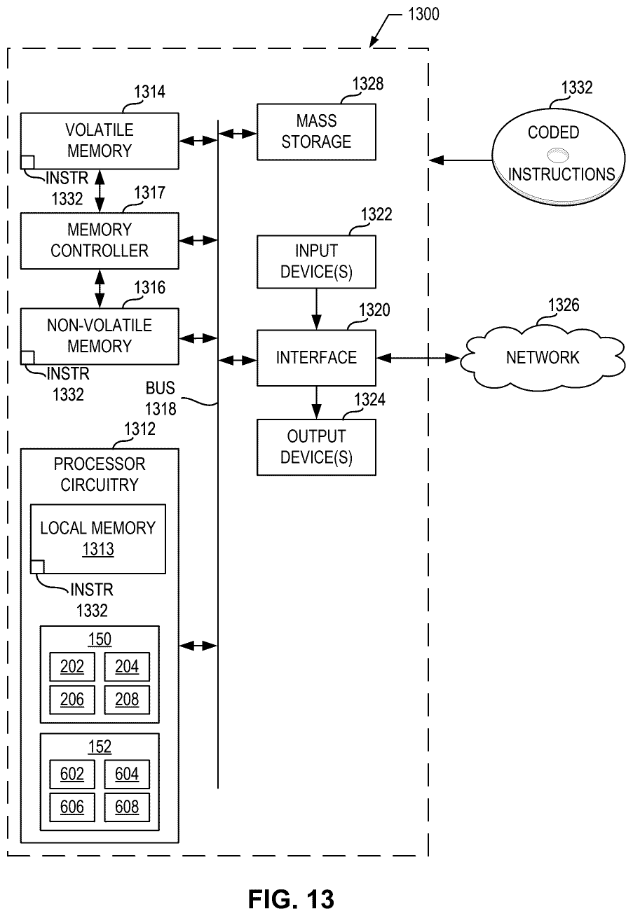

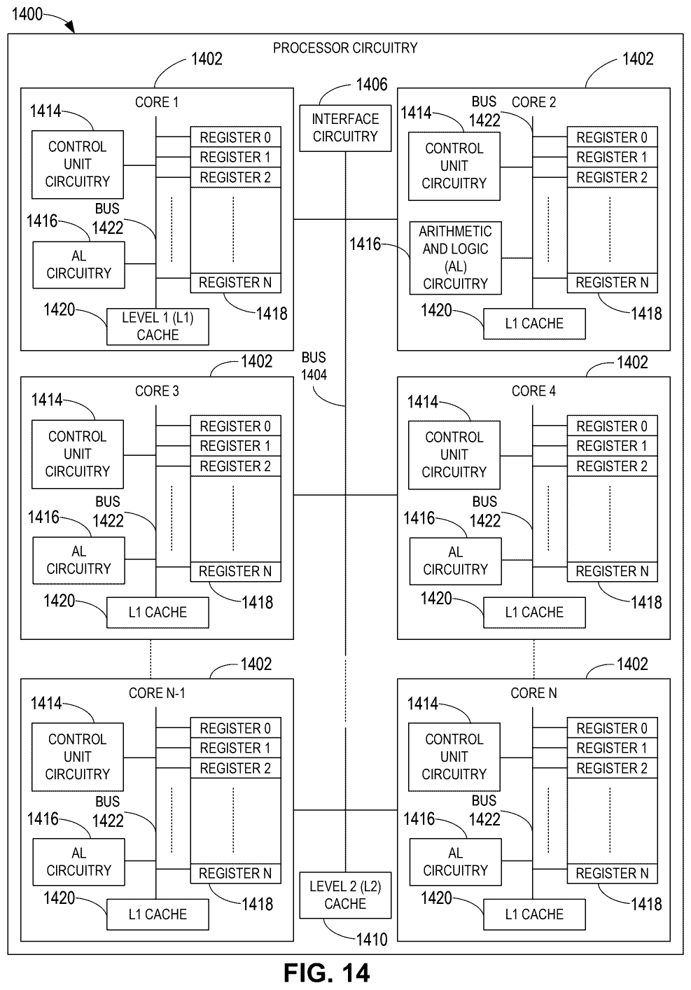

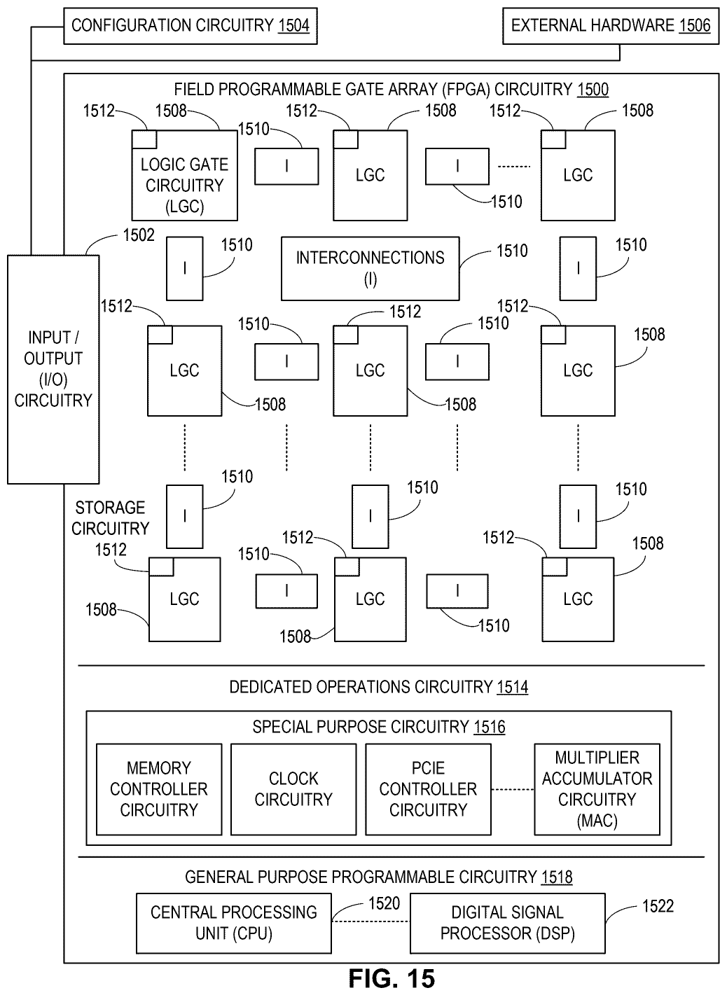

In some examples, the mesh circuitry includes means for mesh management. For example, the means for mesh management may be implemented by mesh circuitry 150. In some examples, the node request circuitry includes means for managing node requests. For example, the means for managing node requests may be implemented by node request circuitry 202. In some examples, the node capability circuitry includes means for determining node capabilities. For example, the means for determining node capabilities may be implemented by node capability circuitry 204. In some examples, the device membership circuitry includes means for determining node membership. For example, the means for determining node membership may be implemented by device membership circuitry 206. In some examples, the node inference circuitry includes means for managing inference. For example, the means for managing inference may be implemented by inference circuitry 208. In some examples, the mesh circuitry 150, the node request circuitry 202, the node capability circuitry 204, the device membership circuitry 206 and/or the inference circuitry 208 may be instantiated by programmable circuitry such as the example programmable circuitry 1312 of FIG. 13. For instance, the aforementioned circuitry may be instantiated by the example microprocessor 1400 of FIG. 14 executing machine executable instructions such as those implemented by at least the blocks of FIGS. 9-12. In some examples, the aforementioned circuitry may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

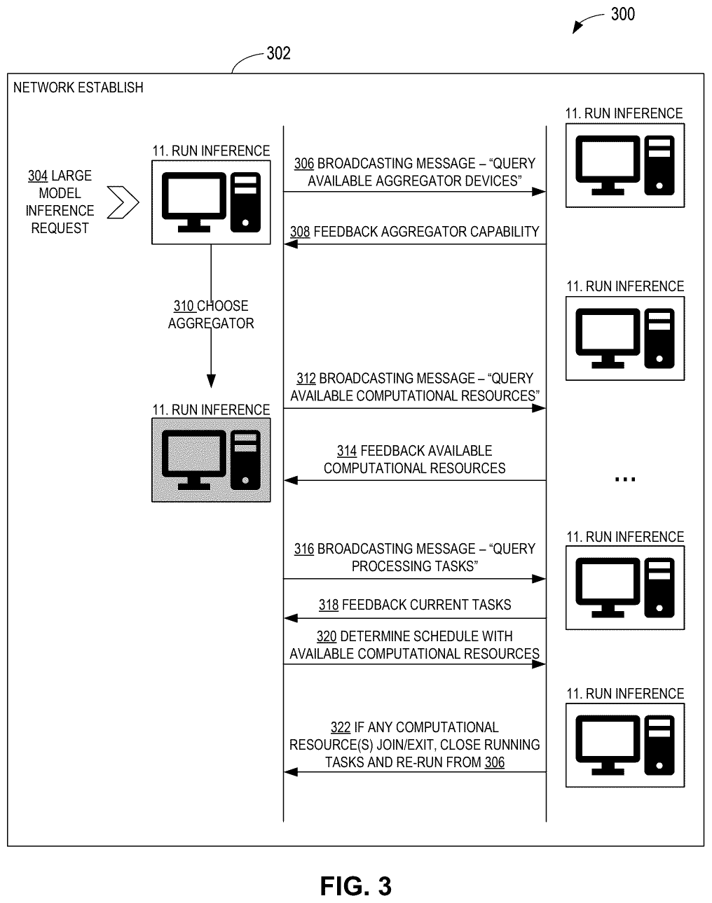

In operation, and in view of an example mesh management workflow 300 of FIG. 3, the mesh circuitry 150 initiates and/or otherwise establishes a mesh network of compute devices (see 302), such as two or more active compute devices 102 and/or aggregator resources 104. The example node request circuitry 202 determines whether an inference request has occurred within the mesh environment 100 (see 304). If not, then the node request circuitry 202 continues to wait for such an occurrence. However, in response to an inference request from at least one compute device (see 304), the node request circuitry 202 broadcasts a query to identify available aggregator devices within the mesh environment 100 that may be capable of satisfying the inference request (see 306). Because all compute devices of the mesh environment 100 include respective mesh circuitry 150 and scheduling circuitry 152 (described in further detail below), the node capability circuitry 204 of active and/or otherwise available aggregator resources 104 responds to the query in the affirmative to indicate it is available for scheduling operations (see 308). In some examples, capability parameters include information associated with the computing capabilities of the aggregator resources 104, such as memory size, storage size, processor type(s), number of cores, etc.

The example node request circuitry 202 selects one of the available aggregator resources to manage the model inference request (see 310). In some examples, the selection is based on proximity to a compute device that received and/or otherwise obtained the model inference request. The node request circuitry 202 of the selected aggregator resource transmits a query throughout the mesh environment 100 to identify all available computational resources (e.g., computational resources that are not already designated as aggregator resources) (see 312), and responding ones of the available computational resources transmit their respective replies as being available (see 314). Additionally, the available computational resources transmit their respective configurations based on, but not limited to their computational type(s) (e.g., CPU, GPU, ASIC, FPGA, etc.), number of cores, amount and/or type of memory, etc. Generally speaking, the particular capabilities of each compute device is relevant when scheduling models and/or portions of models to be processed by respective ones of the compute devices within the mesh environment 100.

The example node request circuitry 202 transmits and/or otherwise broadcasts one or more query messages to compute devices of the mesh environment 100 to determine processing tasks that may already be assigned (see 316). Corresponding task assignments, if any, are transmitted back (e.g., to the selected aggregator resource) by the node capability circuitry 204 (see 318). In some examples, particular compute devices of the mesh environment 100 are previously assigned tasks associated with current inference operations. In those example circumstances, the previously assigned compute devices may maintain their current assignments. However, in some examples the previously assigned compute devices may be re-assigned to process one or more alternate model portions (e.g., based on one or more newly added compute devices having capabilities that exhibit a closer match to objectives of the model portion(s)).

The example scheduling circuitry 152 determines a schedule based on the available compute devices and their corresponding capabilities (see 320). Example scheduling is described in further detail below.

Because heterogeneous environments, such as the example mesh environment 100, may be dynamic with one or more compute devices leaving (e.g., becoming unavailable) or one or more compute devices joining (e.g., becoming available to process model portions), the device membership circuitry 206 determines whether one or more compute devices leave or join the mesh environment (see 322). If so, control returns to the node request circuitry 202 to broadcast a message to query for available aggregator devices (see 306). Generally speaking, efforts to generate the schedule result in improved efficiency when knowledge of available compute devices can be applied to the scheduling arrangement. Additionally, as new compute devices join and/or other compute devices leave the mesh environment 100, the node request circuitry 202 stores any partial inference data in a memory during the reconfiguration so that such partial inference data is not lost when the newly configured mesh environment 100 re-starts inference operations.

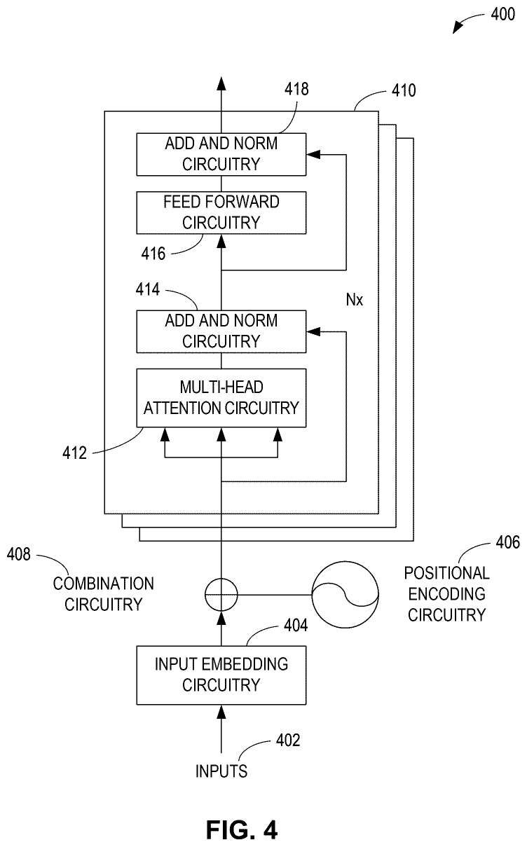

As described above, some examples disclosed herein schedule resources within/on compute devices in a manner that considers combinations of computational resources with particular portions of a model. FIG. 4 is an example model 400 in the form of a transformer structure. In the illustrated example of FIG. 4, the transformer structure 400 includes example inputs 402 (e.g., data structures containing data, such as words), example input embedding circuitry 404, example positional encoding circuitry 406, example combination circuitry 408, and any number of model portions (Nx) 410. The example combination circuitry 408 combines input embeddings (e.g., words and/or characters that have been converted into a numerical representation) and ordering information from the positional encoding circuitry 406. Respective model portions 410 include multi-head attention circuitry 412, first add and norm circuitry 414, feed forward circuitry 416, and second add and norm circuitry 418. Generally speaking, the example multi-head attention circuitry facilitates multi-path analysis of tokens received from the example combination circuitry 408. Outputs of the multi-head attention circuitry 412 are provided to the first add and norm circuitry 414 to facilitate normalization and gradient management before processing by the example feed forward circuitry 416. The example second add and norm circuitry 418 facilitates additional normalization and gradient management in connection with any number of iterations of the example model portion 410.

In operation, the example model 400 of FIG. 4 includes any number of model portions 410. In some examples, the model 400 is a large language model (LLM) or a vision LLM based on the example transformer structure, in which such models may consume a large amount of memory. Due to model memory demands, the example model 400 may not be conveniently and/or otherwise successfully deployed on a single compute device (e.g., a CPU, a GPU, etc.). However, some examples disclosed herein separate model portions 410 in a pipeline manner to facilitate parallel inference among a diverse set of compute devices. In some examples, a pipeline is a data structure (e.g., a sub-data structure of a corresponding assignment data structure) the corresponds to an AI model. As such, an assignment data structure may include any number of pipelines, each of which corresponds to an AI model, in which each AI model may include model portions.

In some examples disclosed herein, the mesh environment 100 includes d compute devices, in which each compute device has different capabilities that, in an aggregate combination with other compute devices may perform model inference in an improved manner. In some examples, a compute device has C_{d} floating operations per second (FLOPs) of computing capability, a total memory storage capability of M_{d}, and an ability to process F_{d} data formats (e.g., floats, bf16, int8, int 4, etc.). Additionally, some example compute devices have an operator type (OP type) set of OP_{d}, a power consumption metric of P_{d}, a data rate transfer metric of T_{d1,d2} (e.g., a data transfer rate from device d₁ to device d₂).

As described in further detail below, some examples disclosed herein schedule in view of K models running on d devices in which a pipeline (k) (e.g., pipeline of model k) includes Nₖ model portions (e.g., sometimes referred to as n model “blocks”) with a target throughput of FPSₖ. For any particular model portion n (e.g., block n) of pipeline k, a given workload consumes w_{k,n} OP/FLOP with a data format f_{k,n}, a memory usage of m_{k,n}, an OP type of op_{k,n}, and an output data size to be transferred to a neighbor portion of o_{k,n}. In view of such example parameters and operating boundaries (parameters), some examples disclosed herein allocate, for each model portion n of a pipeline k, a device allocation of d_{k,n}. In other words, d_{k,n} represents an allocation of portion n on pipeline k with device identifier d_{k,n}.

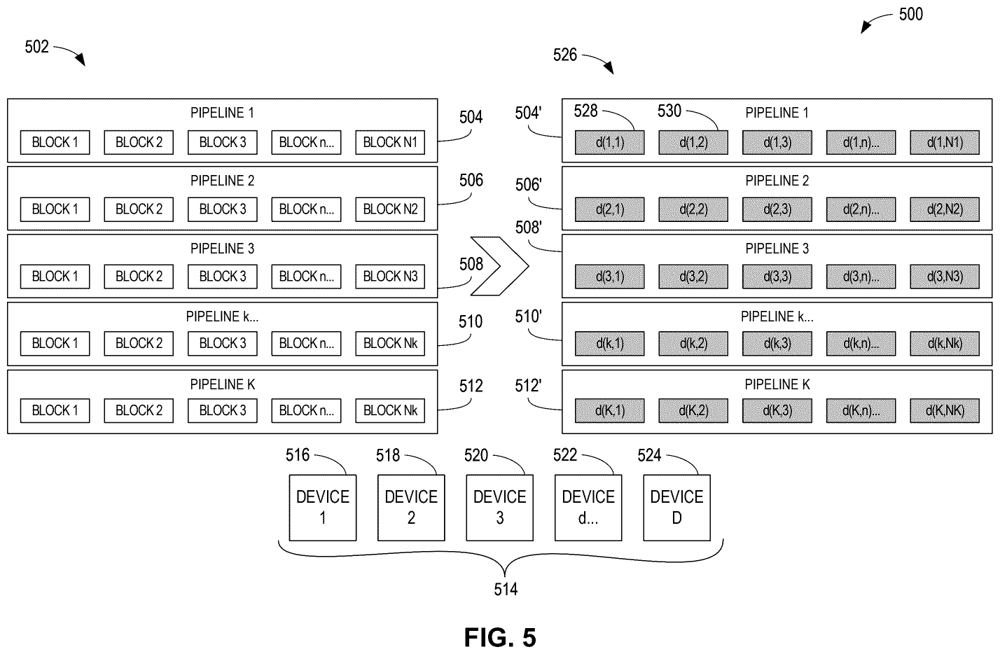

FIG. 5 illustrates an example assignment data structure framework 500. In the illustrated example of FIG. 5, a first assignment data structure 502 includes a number of pipelines (k) that correspond to a number of models that utilize compute devices for inference operations. The example first assignment data structure 502 includes a first pipeline 504, a second pipeline 506, a third pipeline 508, a fourth pipeline 510, and a fifth pipeline 512. While the illustrated example of FIG. 5 includes five (5) separate pipelines corresponding to five (5) models, examples disclosed herein are not limited thereto. Each pipeline (k) includes a number of blocks (n), which are sometimes referred to herein as model portions (n). As described above, a model portion is a portion (e.g., divisible portion) of a model. The example assignment data structure framework 500 also includes a number of available devices 514, which are indicative of available compute devices (e.g., a CPU, a GPU, etc.). In the illustrated example of FIG. 5, the available devices 514 include a first device 516, a second device 518, a third device 520, a fourth device 522, and a fifth device 524. However, the example first assignment data structure 502 does not yet have particular ones of the available devices 514 assigned to respective ones of the portions (n). Some examples disclosed herein allocate devices 514 to portions (n) for model inference.

The illustrated example of FIG. 5 includes a second assignment data structure 526 showing that each block includes an assigned device. The example second assignment data structure 526 includes the same example pipelines that are identified with a prime (′) representation. For instance, the first pipeline 504 of the first assignment data structure 502 is represented as the first pipeline 504′ of the second assignment data structure 526. The example first pipeline 504′ of the second assignment data structure 526 includes a first pairing 528 of the first portion (n) of the first pipeline (k), which is designated as d(1,1). In some examples, a pairing represents an assigned combination of a device (d) and a model portion (n) within a pipeline (k). Similarly, the example first pipeline 504′ of the second assignment data structure 526 includes a second pairing 530 of the second portion (n) of the first pipeline (k), which is designated as d(1,2). The example second assignment data structure 526 represents device assignments for any number of models that are to utilize compute devices during inference operations. For instance, the example second assignment data structure 526 will utilize five (5) separate devices 514 to perform inference on five (5) separate models. In operation during inference, the first pipeline 504′ will utilize a first one of the devices 514 with the first pairing 528, the output of which will serve as the input to the second pairing 530. Further, the first pipeline 504′ will utilize any one of the devices 514 with the second pairing 530, and so on. In some examples, the same available one of the devices 514 is utilized one or more times in any pipeline depending on the capabilities of the device, the demands of the model portion, and/or the fitness score of the second assignment data structure, as described in further detail below.

In some examples disclosed herein, an evolutionary algorithm (EA) (sometimes referred to as a genetic algorithm (GA)) is structured to determine combinations of pairings of (a) available compute devices and (b) model portions (e.g., blocks). In some examples, a device allocation chain of a given pipeline d_{k, 1 . . . Nk} is referred to as a DNA sequence of chromosome k and each d_{k,n} is a nucleotide of that DNA. In some examples disclosed herein, a particular combination of pairings may work better or worse, in which a relatively better performing assignment data structure is determined through the application of the EA. In some examples, EA operations include initialization, evaluation, selection, crossover, mutation, replacement, and termination when one or more stopping criteria (e.g., at least one stopping criterion) are identified.

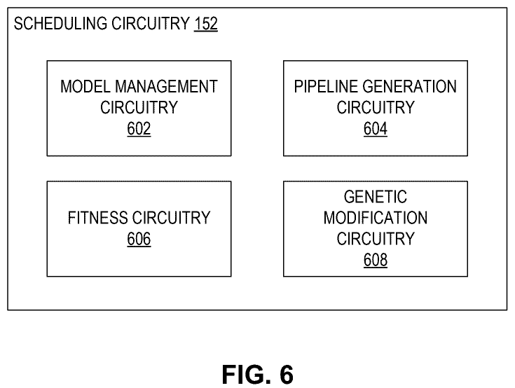

FIG. 6 is a block diagram is an example implementation of the scheduling circuitry 152 of FIG. 1 to schedule resources of the mesh network 100. The scheduling circuitry 152 of FIG. 6 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the scheduling circuitry 152 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

The illustrated example scheduling circuitry 152 of FIG. 6 includes example model management circuitry 602, example pipeline generation circuitry 604, example fitness circuitry 606, and example genetic modification circuitry 608.

In some examples, the scheduling circuitry 152 is instantiated by programmable circuitry executing scheduling instructions and/or configured to perform operations such as those represented by the flowchart(s) of FIGS. 9-12. In some examples, the model management circuitry 602 is instantiated by programmable circuitry executing model management instructions and/or configured to perform operations such as those represented by the flowchart(s) of FIGS. 9-12. In some examples, the pipeline generation circuitry 604 is instantiated by programmable circuitry executing pipeline generation instructions and/or configured to perform operations such as those represented by the flowchart(s) of FIGS. 9-12. In some examples, the fitness circuitry 606 is instantiated by programmable circuitry executing fitness determination instructions and/or configured to perform operations such as those represented by the flowchart(s) of FIGS. 9-12. In some examples, the genetic modification circuitry 608 is instantiated by programmable circuitry executing genetic modification instructions and/or configured to perform operations such as those represented by the flowchart(s) of FIGS. 9-12.

In some examples, the scheduling circuitry includes means for scheduling. For example, the means for scheduling may be implemented by scheduling circuitry 152. In some examples, the model management circuitry includes means for model management. For example, the means for model management may be implemented by model management circuitry 602. In some examples, the pipeline generation circuitry includes means for pipeline generation. For example, the means for pipeline generation may be implemented by pipeline generation circuitry 604. In some examples, the fitness circuitry includes means for fitness determination. For example, the means for fitness determination may be implemented by fitness circuitry 606. In some examples, the genetic modification circuitry includes means for genetic modification. For example, the means for genetic modification may be implemented by genetic modification circuitry 608. In some examples, the scheduling circuitry 152, the model management circuitry 602, the pipeline generation circuitry 604, the fitness circuitry 606, and/or the genetic modification circuitry 608 may be instantiated by programmable circuitry such as the example programmable circuitry 1312 of FIG. 13. For instance, the aforementioned circuitry may be instantiated by the example microprocessor 1400 of FIG. 14 executing machine executable instructions such as those implemented by at least the blocks of FIGS. 9-12. In some examples, the aforementioned circuitry may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In operation, the model management circuitry 602 obtains one or more models to be considered for inference operations using one or more compute devices. The models may be divided and/or otherwise partitioned in to one or more blocks or portions that, in the aggregate, satisfy computational objectives of the model. In some examples, models are referred to herein as “inference models.” The pipeline generation circuitry 604 generates a quantity (e.g., a number of) of pipelines corresponding to the quantity (e.g., a number of) inference models to be considered for scheduling, as shown by the first assignment data structure 502 of FIG. 5. In some examples disclosed herein, an assignment data structure is referred to herein as an “individual.” In particular, the example first pipeline 504 corresponds to a first inference model, the example second pipeline 506 corresponds to a second inference model, and so on. Additionally, the example first pipeline 504 includes five “blocks” or portions of the inference model that may be assigned to separate compute devices during inference operations.

The example pipeline generation circuitry 604 generates and/or otherwise assigns a quantity of (e.g., a number of) assignment data structures, each of which are analyzed to determine different combinations of model portions to compute devices in an effort to identify one or more assignment data structures that exhibit a relatively highest fitness score. Each one of the assignment data structures generated by the pipeline generation circuitry may initially be randomly assigned to have a model portion paired with a compute device. Each one of the generated assignment data structures represents one potential solution for scheduling inference models with compute devices.

In some examples disclosed herein, the pipeline generation circuitry 604 verifies that compute device assignments to model portions (e.g., blocks) satisfy restrictions based on compute device memory capabilities, data format processing capabilities and/or OP type capabilities. In some examples disclosed herein, the pipeline generation circuitry 604 allows or prevents a random compute device assignment to a model portion in a manner consistent with example Equation 1.

$$∀ d ∈ D , {m}_{d} < {M}_{d} , \\ wherein {m}_{d} = {\sum }_{k = 0 , n = 0}^{K , Nk} \{ \begin{matrix}{m}_{k , n} & if ( {d}_{k , n} = ? d ) \\ 0 & if ( {d}_{k , n} != d )\end{matrix} . \qquad Equation 1$$

In the illustrated example of Equation 1, m_{d} represents total memory usage m on device d. In some examples disclosed herein, the pipeline generation circuitry 604 allows or prevents a random compute device assignment to a model portion in a manner consistent with example Equation 2.

$$∀ d ∈ D ∀ k ∈ K ∀ n ∈ {N}_{k} , {f}_{k , n} ∈ {F}_{d} , {op}_{k , n} ∈ {OP}_{d} , if ( {d}_{k , n} = ? d ) . \qquad Equation 2$$

In the illustrated example of Equation 2, data format f_{k,n} of block n in pipeline k is a subset of F_{d}, which is the data format device d can support. Additionally, OP type op_{k,n} of block n in pipeline k is also a subset of OP_{d}, which is the OP type supported on device d.

After the quantity of assignment data structures is generated by the pipeline generation circuitry 604, in which an original batch of such data structures is sometimes referred to as a “parent generation” of assignment data structures, the example fitness circuitry 606 calculates fitness scores for each assignment data structure. The calculation of one or more fitness scores is sometimes referred to as an evaluation phase of the EA. In some examples disclosed herein the fitness calculation measures different types of performance metrics of an assignment data structure. In some examples the fitness scores determine a throughput metric, a latency metric, and/or a power consumption metric. Generally speaking, the throughput metric may be particularly relevant to cloud service providers. In some examples a benchmark throughput metric is established as a target value provided by the cloud service provider (e.g., FPSₖ). Improvements to the baseline may be referred to as a throughput boost and determined by the example fitness circuitry 606 as a fitness throughput metric in a manner consistent with example Equation 3.

$${fit}_{th} = {min}_{d ∈ D} \frac{{C}_{d}}{{w}_{d}} , \\ where {w}_{d} = {\sum }_{k = 0 , n = 0}^{K , Nk} \{ \begin{matrix}{w}_{k , n} \cdot {FPS}_{k} , & if ( {d}_{k , n} = ? d ) \\ 0 , & if ( {d}_{k , n} != d )\end{matrix} . \qquad Equation 3$$

In the illustrated example of Equation 3, C_{d} reflects a computing capacity of device d (e.g., a computational resource), and w_{d} reflects a workload on device d, and a minimum ratio over all devices dϵD is determined.

In some examples the latency fitness metric determined by the example fitness circuitry 606 considers an average ratio of a target pipeline latency Lₖ to an actual latency observation(s) lk for each pipeline k in a manner consistent with example Equation 4.

$${fit}_{l a} = {average}_{k ∈ K} \frac{{L}_{k}}{{l}_{k}} , \\ where {l}_{k} = {\sum }_{n = 0}^{{N}_{k}} ( \frac{{w}_{k , n}}{{C}_{dk , n}} + \frac{{o}_{k , n}}{{T}_{d k , n , dk , n + 1}} ) . \qquad Equation 4$$

In the illustrated example of Equation 4, lₖ is the latency represented as the sum of two components, one being a computation latency calculated by dividing the workload w_{k,n} (OP/FLOP) over C_{dk,n} (OP/FLOP per second), plus a second component representing a data transfer latency calculated by dividing data size o_{k,n} over the transfer rate between two devices T_{dk,n, dk,n+1}.

In some examples the power consumption fitness determined by the example fitness circuitry 606 considers the sum of power consumption of each device d running each block's workload in a manner consistent with example Equation 5.

$${fit}_{po} = {\sum }_{k = 0 , n = 0}^{K , {N}_{k}} \frac{{w}_{k , n} \cdot {FPS}_{k} \cdot {P}_{dk , n}}{{C}_{dk , n}} . \qquad Equation 5$$

Based on the calculated fitness scores for each assignment data structure, the example genetic modification circuitry 608 generates offspring data structures. In some examples disclosed herein, the generation of offspring data structures is referred to as “crossover” that, in some examples, is facilitated by exchanging pairings between different pipelines of a selected assignment data structure. Stated differently, the offspring data structures represent different permutations of pairings of XPU resources to model portions, some of which result in relatively better or worse schedules. Additionally, mutation of one or more of the generated offspring data structures iterates until a stopping condition occurs, in which the relatively best performing (e.g., relatively best fitness scores) assignment data structure(s) are selected for inference operation(s). In some examples, the scheduling circuitry 152 causes a plurality of assignment data structures having a relatively highest rank (e.g., a rank based on fitness scores of the plurality of assignment data structures that have iterated through crossover and mutation operations) to be identified (e.g., labelled or tagged) for inference.

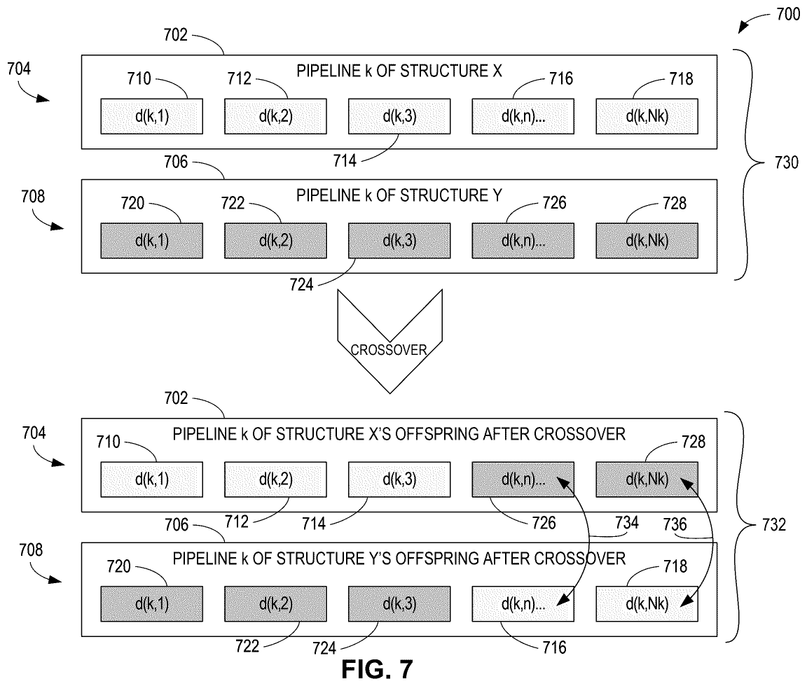

During crossover operations, the example genetic modification circuitry 608 selects a pair of assignment data structures, which may be a pair from the “parent generation.” The genetic modification circuitry 608 selects a first pipeline of a first assignment data structure and a second pipeline of a second assignment data structure, as shown in the illustrated example of FIG. 7. The illustrated example of FIG. 7 illustrates example crossover operations 700 for a portion of the parent generation of assignment data structures. The illustrated example of FIG. 7 includes a first pipeline 702 of a first data structure 704, and a second pipeline 706 of a second data structure 708. As described above, the first data structure 704 (and all such data structures) may include any number of pipelines, and only the first pipeline 702 and the second pipeline 706 are shown for purposes of convenience and explanation. Stated differently, the example first data structure 704 and the example second data structure 708 may include two or more pipelines (e.g., models) therein, in which each pipeline includes model portions.

In the illustrated example of FIG. 7, the first pipeline 702 includes a first pairing 710, a second pairing 712, a third pairing 714, a fourth pairing 716, and a fifth pairing 718. In the illustrated example of FIG. 7, the second pipeline 706 includes a first pairing 720, a second pairing 722, a third pairing 724, a fourth pairing 726, and a fifth pairing 728. As described above, initial pairings may be generated in a random manner when the parent generation of assignment data structures is generated.

The genetic modification circuitry 608 exchanges at least one pairing between two separate pipelines. The illustrated example of FIG. 7 includes a pre-crossover assignment data structure arrangement 730, and a post-crossover assignment data structure arrangement 732, which represents an “offspring” data structure. For instance, the pre-crossover assignment data structure arrangement 730 illustrates a data structure prior to crossover operations being performed thereon. During crossover operations, the post-crossover assignment data structure arrangement 732 of the illustrated example of FIG. 7 shows an example first crossover event 734 and an example second crossover event 736. The example first crossover event 734 is caused by the genetic modification circuitry 608 exchanging (crossover) the fourth pairing 716 of the first pipeline 702 of the first data structure 704 with the fourth pairing 726 of the first pipeline 708 of the second data structure 708. Additionally, the example second crossover event 736 is caused by the genetic modification circuitry 608 exchanging (crossover) the fifth pairing 718 of the first pipeline 702 of the first data structure 704 with the fifth pairing 728 of the second pipeline 706 of the second data structure 708. In effect, the example crossover operations have swapped the pairings to generate offspring. In some examples, exchanges of the pairings between pipelines occurs in a random manner.

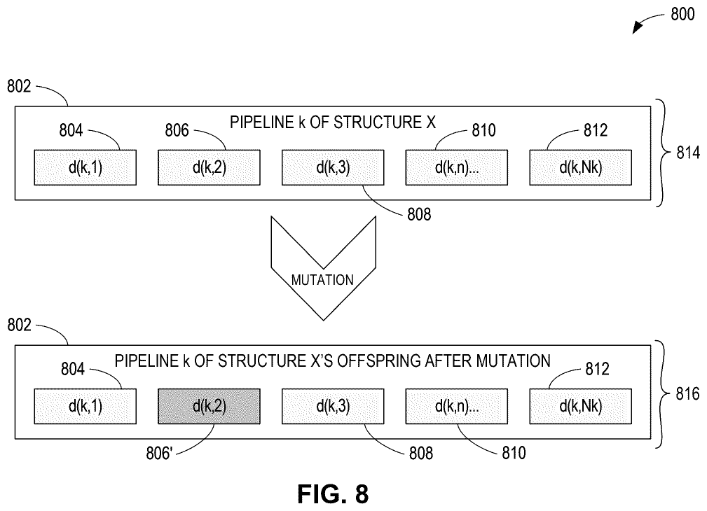

The example genetic modification circuitry 608 also facilitates mutation of the pipelines by selecting an assignment data structure, and then mutating and/or otherwise changing at least one pairing from at least one pipeline within the selected assignment data structure. In some examples the assignment data structure is selected randomly, in some examples the at least one pipeline is selected randomly, and in some examples the at least one pairing is selected randomly. FIG. 8 illustrates example mutation operations 800 for a portion of the parent generation of assignment data structures. The illustrated example of FIG. 8 includes a first pipeline 802 within a selected assignment data structure. While the illustrated example of FIG. 8 only shows one pipeline (e.g., the first pipeline 802), examples disclosed herein are not limited thereto.

The example first pipeline 802 of FIG. 8 includes a first pairing 804, a second pairing 806, a third pairing 808, a fourth pairing 810, and a fifth pairing 812. The illustrated example of FIG. 8 includes a pre-mutation (e.g., not yet changed) pipeline arrangement 814 and a post-mutation (e.g., after changes have been applied) pipeline arrangement 816 (e.g., a portion of a mutated (e.g., changed) offspring data structure). The illustrated example of FIG. 8 includes a mutation event 818 in which an assigned device to the example second pairing 806 is mutated and/or otherwise changed to a different device (e.g., a different XPU resource than what was previously assigned). In the illustrated example of FIG. 8, the mutated pairing is referred to as 806′ (prime) to indicate that it has been mutated, changed and/or otherwise transformed to an alternate device assignment. In some examples the genetic modification circuitry 608 mutates any number of pairings within all assignment data structures, while in some examples only some of the assignment data structures are operated on for mutation of one or more pairings.

While an example manner of implementing the mesh circuitry 150 and the scheduling circuitry 152 of FIG. 1 is illustrated in FIGS. 2 and 6, one or more of the elements, processes, and/or devices illustrated in FIGS. 2 and/or 6 may be combined, divided, re-arranged, omitted, eliminated, and/or implemented in any other way. Further, the example node request circuitry 202, the example node capability circuitry 204, the example XPU membership circuitry 206, the example inference circuitry 208, and/or, more generally, the example mesh circuitry 150 of FIG. 2, may be implemented by hardware alone or by hardware in combination with software and/or firmware. Additionally, the example model management circuitry 602, example pipeline generation circuitry 604, example fitness circuitry 606, example genetic modification circuitry 608, and/or, more generally, the example scheduling circuitry 152 of FIG. 6, may be implemented by hardware alone or by hardware in combination with software and/or firmware. Thus, for example, any of the example node request circuitry 202, the example node capability circuitry 204, the example device membership circuitry 206, the example inference circuitry 208, the example model management circuitry 602, example pipeline generation circuitry 604, example fitness circuitry 606, example genetic modification circuitry 608, and/or, more generally, the example mesh circuitry 150 and/or the example scheduling circuitry 152, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example mesh circuitry 150 of FIG. 2 and/or the example scheduling circuitry 152 of FIG. 6 may include one or more elements, processes, and/or devices in addition to, or instead of, those illustrated in FIGS. 2 and/or 6, and/or may include more than one of any or all of the illustrated elements, processes and devices.

Flowchart(s) representative of example machine readable instructions, which may be executed by programmable circuitry to implement and/or instantiate the mesh circuitry 150 of FIG. 2 and/or the scheduling circuitry 152 of FIG. 6 and/or representative of example operations which may be performed by programmable circuitry to implement and/or instantiate the mesh circuitry 150 of FIG. 2 and the scheduling circuitry 152 of FIG. 6, are shown in FIGS. 9-12. The machine readable instructions may be one or more executable programs or portion(s) of one or more executable programs for execution by programmable circuitry such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9-12, many other methods of implementing the example mesh circuitry 150 and/or the example scheduling circuitry 152 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 9-12 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of example machine readable instructions and/or example operations 900 that may be executed, instantiated, and/or performed by programmable circuitry to schedule resources for model inference. The example machine-readable instructions and/or the example operations 900 of FIG. 9 begin at block 902, at which the example mesh circuitry 150 initiates network discovery operations. In some examples disclosed herein the mesh circuitry 150 establishes a mesh network of computational resources, such as the example mesh environment 100 of FIG. 1. The example node request circuitry 202 determines if an inference request has been received and/or otherwise obtained (block 904). If not, the example operations 900 wait for such an occurrence. Based on the node request circuitry 202 obtaining, detecting and/or otherwise determining an inference request has occurred (block 904), the node request circuitry 202 broadcasts queries to identify available aggregator devices (block 906). The example node capability circuitry 204 obtains one or more indications of availability from available aggregator devices (block 908). In some examples the node capability circuitry 204 obtains capability parameters indicative of information associated with the computing capabilities of the aggregator devices/resources (e.g., aggregator resources 104 of FIG. 1).

The example node request circuitry 202 selects an available aggregator device (block 910) and broadcasts a query to identify available non-aggregator resources (block 912). The node request circuitry 202 obtains available resources (e.g., computational resources) that respond to the query (block 914), and broadcasts another query to determine which ones of those available resources have any current task assignments (block 916). In some examples, current task assignments correspond to resources that were participating in one or more inference operations prior to one or more resources leaving or joining the mesh network 100. The node capability circuitry 204 obtains task assignment information from the responding resources (block 918).

The example scheduling circuitry 152 determines a schedule of which compute devices are to execute which model portions (block 920), as described above and in further detail below. After the scheduling circuitry 152 determines, establishes and/or otherwise assigns a schedule (block 920), the inference circuitry 208 initiates inference operations (block 922). In some examples the inference circuitry 208 initiates inference operations only when the mesh network 100 is in a steady-state condition where no resources are being added or leaving. The example device membership circuitry 206 monitors the mesh network 100 for instances where one or more resources joins or leaves (block 924). If transient actions such as a resource join or a resource leave event occur (block 924), the device membership circuitry 206 stops all inference operations (block 926) and saves any data that has been collected and/or otherwise processed from each resource in the network (block 928). Control then returns to block 906, where the example node request circuitry 202 determines the current list and/or state of the mesh network 100 by broadcasting queries to identify available aggregator devices. On the other hand, if the mesh network 100 is still in a steady state with no transient resource additions or resource losses (block 924), control returns to block 904 to continue to monitor for an inference request.

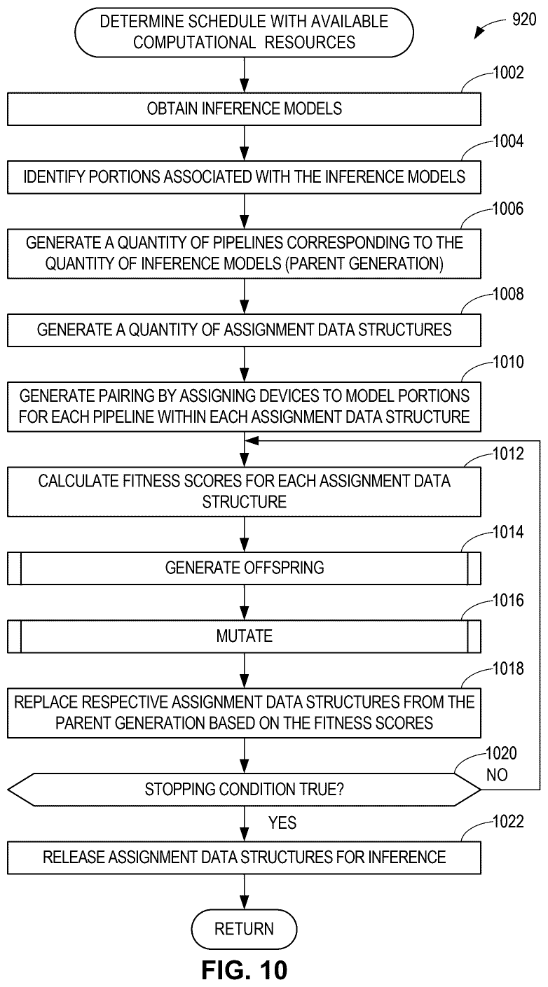

FIG. 10 includes additional detail corresponding to operations to determine a schedule (block 920). In the illustrated example of FIG. 10, the model management circuitry 602 obtains inference models to be used for inference operations (block 1002), and identifies portions of the models (block 1004). The example pipeline generation circuitry 604 generates and/or otherwise assigns a quantity of pipelines corresponding to the quantity of inference models (block 1006). In some examples disclosed herein the initial generation of the inference models is referred to as a parent generation of inference models that are populated with random device assignments. The example pipeline generation circuitry 604 generates a quantity of assignment data structures (block 1008), in which each assignment data structure includes the number of pipelines equal to the number of models to be used for inference operations. The pipeline generation circuitry 604 generates pairings by assigning devices to model portions for each pipeline within each generated assignment data structure (block 1010).

The example fitness circuitry 606 calculates one or more fitness scores for each assignment data structure (block 1012). As described above, fitness scores may be based on throughput metrics, latency metrics and/or power consumption metrics in a manner consistent with example Equations 3, 4 and 5. The example genetic modification circuitry 608 generates offspring (block 1014) as described above in connection with FIG. 7, and mutates the offspring (block 1016) as described above in connection with FIG. 8. The genetic modification circuitry 608 replaces one or more of the assignment data structures from a prior iteration (block 1018) (e.g., the parent generation if this is a first iteration of crossover and mutation), and determines whether a stopping condition has occurred (block 1020). If not, then control returns to block 1012 to perform another operation of fitness scoring, crossover (e.g., generating offspring), mutation, and replacement. However, if the genetic modification circuitry 608 determines that a stopping condition occurs, one or more remaining assignment data structures is selected and released by the scheduling circuitry 152 as the schedule to be used during inference operations (block 1022).

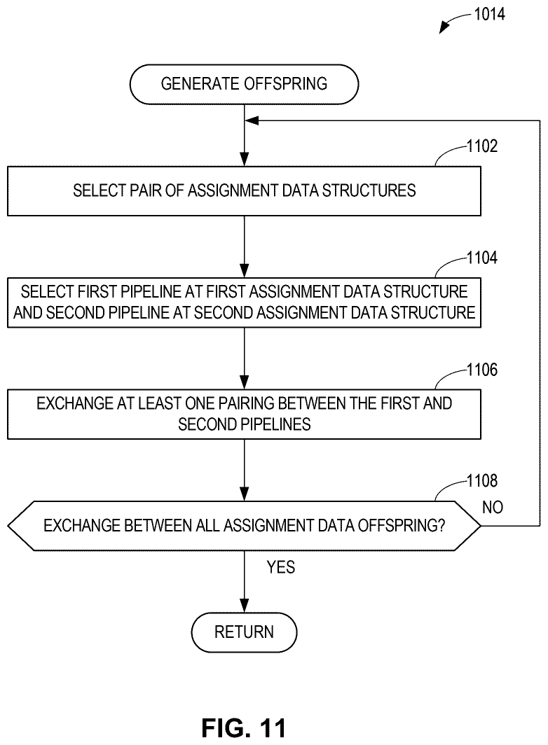

FIG. 11 illustrates additional detail associated with generating offspring of block 1014. In the illustrated example of FIG. 11, the genetic modification circuitry 608 selects a pair of assignment data structures 1102, such as the example first data structure 704 and the second data structure 708 shown in FIG. 7. The genetic modification circuitry 608 selects a first pipeline at the first assignment data structure and a second pipeline at the second assignment data structure (block 1104). Between the two selected data structures, the genetic modification circuitry 608 exchanges at least one pairing between the first and second pipelines (block 1106). The genetic modification circuitry 608 determines if an exchange (e.g., a crossover) has occurred between all assignment data offspring (block 1108) and if not, control returns to block 1102 to select another pair of assignment data structures. Otherwise control returns to block 1016.

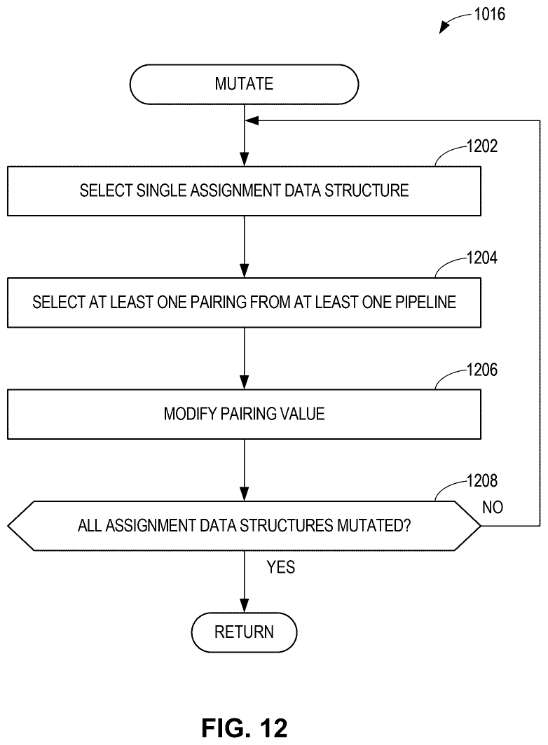

FIG. 12 illustrates additional detail of mutation of block 1016. In the illustrated example of FIG. 12, the genetic modification circuitry 608 selects one of the assignment data structures (block 1202), and selects at least one pairing from a pipeline therein (block 1204). The genetic modification circuitry 608 modifies the selected pairing values to designate an alternate computational resource (block 1206). In some examples, the alternate computational resource is selected in a random manner. The genetic modification circuitry 608 determines if all assignment data structures have had at least one mutation operation (block 1208), and if not, control returns to block 1202 to select another assignment data structure. Otherwise the example program 1016 returns.

FIG. 13 is a block diagram of an example programmable circuitry platform 1300 structured to execute and/or instantiate the example machine-readable instructions and/or the example operations of FIGS. 9-12 to implement the mesh circuitry 150 of FIG. 2 and/or the scheduling circuitry 152 of FIG. 6. The programmable circuitry platform 1300 can be, for example, a server, a personal computer, a workstation, a self-learning machine (e.g., a neural network), a mobile device (e.g., a cell phone, a smart phone, a tablet such as an iPad™), an Internet appliance, a gaming console, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, VPUs, DSPs, and/or microcontrollers from any desired family or manufacturer. The programmable circuitry 1312 may be implemented by one or more semiconductor based (e.g., silicon based) devices. In this example, the programmable circuitry 1312 implements the example node request circuitry 202, the example node capability circuitry 204, the example device membership circuitry 206, the example inference circuitry 208, the example mesh circuitry 150, the example model management circuitry 602, the example pipeline generation circuitry 604, the example fitness circuitry 606, the example genetic modification circuitry 608, and the example scheduling circuitry 152.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1332, which may be implemented by the machine readable instructions of FIGS. 9-12, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 9-12 to effectively instantiate the circuitry of FIGS. 2 and/or 6 as logic circuits to perform operations corresponding to those machine readable instructions. In some such examples, the circuitry of FIGS. 2 and/or 6 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 9-12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine readable instructions represented by the flowchart(s) of FIGS. 9-12 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 9-12. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-12. As such, the FPGA circuitry 1500 may be configured and/or structured to effectively instantiate some or all of the operations/functions corresponding to the machine readable instructions of the flowchart(s) of FIGS. 9-12 as dedicated logic circuits to perform the operations/functions corresponding to those software instructions in a dedicated manner analogous to an ASIC. Therefore, the FPGA circuitry 1500 may perform the operations/functions corresponding to the some or all of the machine readable instructions of FIGS. 9-12 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine readable instructions of FIGS. 9-12 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine readable instructions represented by the flowchart(s) of FIGS. 9-12 to perform first operation(s)/function(s), the FPGA circuitry 1500 of FIG. 15 may be configured and/or structured to perform second operation(s)/function(s) corresponding to a second portion of the machine readable instructions represented by the flowcharts of FIG. 9-12, and/or an ASIC may be configured and/or structured to perform third operation(s)/function(s) corresponding to a third portion of the machine readable instructions represented by the flowcharts of FIGS. 9-12.

It should be understood that some or all of the circuitry of FIGS. 2 and/or 6 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIGS. 2 and/or 6 may be instantiated, for example, in one or more threads executing concurrently and/or in series. For example, the microprocessor 1400 of FIG. 14 may execute machine readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIGS. 2 and/or 6 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

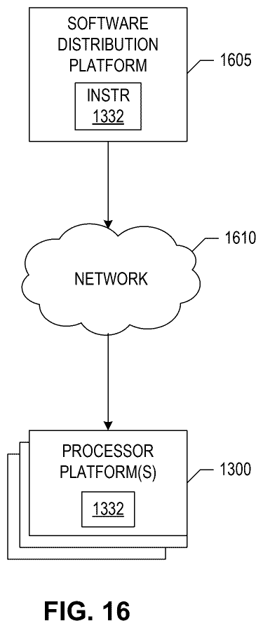

A block diagram illustrating an example software distribution platform 1605 to distribute software such as the example machine readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1332, which may correspond to the example machine readable instructions of FIGS. 9-12, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1605. For example, the software, which may correspond to the example machine readable instructions of FIG. 9-12, may be downloaded to the example programmable circuitry platform 1300, which is to execute the machine readable instructions 1332 to implement the mesh circuitry 150 and/or the scheduling circuitry 152. In some examples, one or more servers of the software distribution platform 1605 periodically offer, transmit, and/or force updates to the software (e.g., the example machine readable instructions 1332 of FIG. 13) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that schedule a plurality of model portions to be respectively executed on heterogeneous computational resources. In some examples disclosed herein, mere user selection of computational resources to model portions fails to consider a volume of permutations that can be tested for fitness. Some examples disclosed herein perform iterative permutations of assignment data structures to be generated in which each iteration results in an improved arrangement set of data structures with improved fitness scores. Disclosed systems, apparatus, articles of manufacture, and methods improve the efficiency of using a computing device by discontinuing iterative permutation exploration when a stopping condition is determined, which conserves energy, reduces exploration time, and reduces heat generation. Disclosed systems, apparatus, articles of manufacture, and methods improve a speed of inference by identifying improved arrangements of data structures based on the fitness scores. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to schedule resources for model inference are disclosed herein. Further examples and combinations thereof include the following:

Example 1 includes an apparatus comprising interface circuitry, machine-readable instructions, and at least one processor circuit to be programmed by the machine-readable instructions to generate first assignment data structures to respectively assign portions of artificial intelligence (AI) models to respective compute devices for execution, change the assignments in the first assignment data structures to generate offspring data structures, change ones of the assignments in the offspring data structures, replace ones of the first assignment data structures with ones of the changed offspring data structures to generate second assignment data structures, and assign the portions of the AI models for execution by the compute devices based on the second assignment data structures.

Example 2 includes the apparatus as defined in example 1, wherein one or more of the at least one processor circuit is to generate respective pipelines, respective ones of the pipelines corresponding to respective ones of the AI models.

Example 3 includes the apparatus as defined in one or more of examples 2-3, wherein the respective assignment of portions of the AI models to the respective devices includes one or more of the at least one processor circuit to assign, to the respective ones of the pipelines, pairings of (a) one of the portions of the AI models and (b) one of the respective compute devices.

Example 4 includes the apparatus as defined in one or more of examples 1-3, wherein the change of the assignments in the first assignment data structures includes one or more of the at least one processor circuit to exchange first ones of the pairings between first and second ones of the pipelines.

Example 5 includes the apparatus as defined in one or more of examples 1-4, wherein the change of ones of the assignments in the offspring data structures includes one or more of the at least one processor circuit to change the one of the respective compute devices associated with second ones of the pairings.

Example 6 includes the apparatus as defined in one or more of examples 1-3, wherein one or more of the at least one processor circuit is to randomly assign one of the respective compute devices to the one of the portions of the AI model at a first time.

Example 7 includes the apparatus as defined in example 6, wherein one or more of the at least one processor circuit is to randomly exchange a first one of the pairings between a first one of the respective pipelines and a second one of the respective pipelines at a second time.

Example 8 includes the apparatus as defined in one or more of examples 1-7, wherein one or more of the at least one processor circuit is to determine fitness scores for the first assignment data structures.

Example 9 includes the apparatus as defined in one or more of examples 1-8, wherein one or more of the at least one processor circuit is to replace the first assignment data structures with ones of the second assignment data structures based on the fitness scores.

Example 10 includes at least one non-transitory machine-readable medium comprising machine-readable instructions to cause at least one processor circuit to at least generate first assignment data structures to respectively assign portions of artificial intelligence (AI) models to respective compute devices for execution, change the assignments in the first assignment data structures to generate offspring data structures, change ones of the assignments in the offspring data structures, replace ones of the first assignment data structures with ones of the changed offspring data structures to generate second assignment data structures, and assign the portions of the AI models for execution by the compute devices based on the second assignment data structures.

Example 11 includes the at least one non-transitory machine-readable medium as defined in example 10, wherein the machine-readable instructions are to cause one or more of the at least one processor circuit to generate respective pipelines, respective ones of the pipelines corresponding to respective ones of the AI models.

Example 12 includes the at least one non-transitory machine-readable medium as defined in one or more of examples 10-11, wherein the respective assignment of portions of the AI models to the respective devices causes the machine-readable instructions to cause one or more of the at least one processor circuit to assign, to the respective ones of the pipelines, pairings of (a) one of the portions of the AI models and (b) one of the respective compute devices.

Example 13 includes the at least one non-transitory machine-readable medium as defined in one or more of examples 10-12, wherein the change of assignments in the first assignment data structures causes the machine-readable instructions to exchange first ones of the pairings between first and second ones of the pipelines.

Example 14 includes the at least one non-transitory machine-readable medium as defined in one or more of examples 10-13, wherein the change of ones of the assignments in the offspring data structures causes the machine-readable instructions to change the one of the respective compute devices associated with second ones of the pairings.

Example 15 includes the at least one non-transitory machine-readable medium as defined in one or more of examples 10-12, wherein the machine-readable instructions are to cause one or more of the at least one processor circuit to randomly assign one of the respective compute devices to the one of the portions of the AI model at a first time.

Example 16 includes the at least one non-transitory machine-readable medium as defined in example 15, wherein the machine-readable instructions are to cause one or more of the at least one processor circuit to randomly exchange a first one of the pairings between a first one of the respective pipelines and a second one of the respective pipelines at a second time.

Example 17 includes the at least one non-transitory machine-readable medium as defined in one or more of examples 10-16, wherein the machine-readable instructions are to cause one or more of the at least one processor circuit to determine fitness scores for the first assignment data structures.

Example 18 includes the at least one non-transitory machine-readable medium as defined in one or more of examples 10-17, wherein the machine-readable instructions are to cause one or more of the at least one processor circuit to replace the first assignment data structures with ones of the second assignment data structures based on the fitness scores.

Example 19 includes an apparatus comprising means for pipeline generation to generate first assignment data structures to respectively assign portions of artificial intelligence (AI) models to respective compute devices for execution, means for genetic modification to change the assignments in the first assignment data structures to generate offspring data structures, change ones of the assignments in the offspring data structures, and replace ones of the first assignment data structures with ones of the changed offspring data structures to generate second assignment data structures, and means for scheduling to assign the portion of the AI models for execution by the compute devices based on the second assignment data structures.

Example 20 includes the apparatus as defined in example 19, wherein the means for pipeline generation is to generate respective pipelines, respective ones of the pipelines corresponding to respective ones of the AI models.

Example 21 includes the apparatus as defined in one or more of examples 19-20, wherein the means for genetic modification is to assign, to the respective ones of the pipelines, pairings of (a) one of the portions of the AI models and (b) one of the respective compute devices.

Example 22 includes the apparatus as defined in one or more of examples 19-21, wherein the means for genetic modification is to exchange first ones of the pairings between first and second ones of the pipelines.

Example 23 includes the apparatus as defined in one or more of examples 19-22, wherein the means for genetic modification is to change the one of the respective compute devices associated with second ones of the pairings.

Example 24 includes the apparatus as defined in one or more of examples 19-21, wherein the means for pipeline generation is to randomly assign one of the respective compute devices to the one of the portions of the AI model at a first time.

Example 25 includes the apparatus as defined in example 24, wherein the means for genetic modification is to randomly exchange a first one of the pairings between a first one of the respective pipelines and a second one of the respective pipelines at a second time.

Example 26 includes the apparatus as defined in one or more of examples 19-25, further including means for fitness determination to determine fitness scores for the first assignment data structures.

Example 27 includes the apparatus as defined in one or more of examples 19-26, wherein the means for genetic modification is to replace the first assignment data structures with ones of the second assignment data structures based on the fitness scores.

Example 28 includes a method comprising generating first assignment data structures to respectively assign portions of artificial intelligence (AI) models to respective compute devices for execution, generating offspring data structures by changing the assignments in the first assignment data structures, changing ones of the assignments in the offspring data structures, generating second assignment data structures by replacing ones of the first assignment data structures with ones of the changed offspring data structures, and assigning the portion of the AI models for execution by the compute devices based on the second assignment data structures.

Example 29 includes the method as defined in example 28, including generating respective pipelines, respective ones of the pipelines corresponding to respective ones of the AI models.

Example 30 includes the method as defined in one or more of examples 28-29, including assigning, to the respective ones of the pipelines, pairings of (a) one of the portions of the AI models and (b) one of the respective compute devices.

Example 31 includes the method as defined in one or more of examples 28-30, including exchanging first ones of the pairings between first and second ones of the pipelines.

Example 32 includes the method as defined in one or more of examples 28-31, including changing the one of the respective compute devices associated with second ones of the pairings.

Example 33 includes the method as defined in one or more of examples 28-30, including randomly assigning one of the respective compute devices to the one of the portions of the AI model at a first time.

Example 34 includes the method as defined in one or more of examples 28-33, including randomly exchanging a first one of the pairings between a first one of the respective pipelines and a second one of the respective pipelines at a second time.

Example 35 includes the method as defined in one or more of examples 28-34, including determining fitness scores for the first assignment data structures.

Example 36 includes the method as defined in one or more of examples 28-35, including replacing the first assignment data structures with ones of the second assignment data structures based on the fitness scores.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
generate first assignment data structures to respectively assign portions of artificial intelligence (AI) models to respective compute devices for execution;
change the assignments in the first assignment data structures to generate offspring data structures;
change ones of the assignments in the offspring data structures;
replace ones of the first assignment data structures with ones of the changed offspring data structures to generate second assignment data structures; and
assign the portions of the AI models for execution by the compute devices based on the second assignment data structures.

2. The apparatus as defined in claim 1, wherein one or more of the at least one processor circuit is to generate respective pipelines, respective ones of the pipelines corresponding to respective ones of the AI models.

3. The apparatus as defined in claim 2, wherein the respective assignment of portions of the AI models to the respective devices includes one or more of the at least one processor circuit to assign, to the respective ones of the pipelines, pairings of (a) one of the portions of the AI models and (b) one of the respective compute devices.

4. The apparatus as defined in claim 3, wherein the change of the assignments in the first assignment data structures includes one or more of the at least one processor circuit to exchange first ones of the pairings between first and second ones of the pipelines.

5. The apparatus as defined in claim 4, wherein the change of ones of the assignments in the offspring data structures includes one or more of the at least one processor circuit to change the one of the respective compute devices associated with second ones of the pairings.

6. The apparatus as defined in claim 3, wherein one or more of the at least one processor circuit is to randomly assign one of the respective compute devices to the one of the portions of the AI model at a first time.

7. The apparatus as defined in claim 6, wherein one or more of the at least one processor circuit is to randomly exchange a first one of the pairings between a first one of the respective pipelines and a second one of the respective pipelines at a second time.

8. The apparatus as defined in claim 1, wherein one or more of the at least one processor circuit is to determine fitness scores for the first assignment data structures.

9. The apparatus as defined in claim 8, wherein one or more of the at least one processor circuit is to replace the first assignment data structures with ones of the second assignment data structures based on the fitness scores.

10. At least one non-transitory machine-readable medium comprising machine-readable instructions to cause at least one processor circuit to at least:
generate first assignment data structures to respectively assign portions of artificial intelligence (AI) models to respective compute devices for execution;
change the assignments in the first assignment data structures to generate offspring data structures;
change ones of the assignments in the offspring data structures;
replace ones of the first assignment data structures with ones of the changed offspring data structures to generate second assignment data structures; and
assign the portions of the AI models for execution by the compute devices based on the second assignment data structures.

11. The at least one non-transitory machine-readable medium as defined in claim 10, wherein the machine-readable instructions are to cause one or more of the at least one processor circuit to generate respective pipelines, respective ones of the pipelines corresponding to respective ones of the AI models.

12. The at least one non-transitory machine-readable medium as defined in claim 11, wherein the respective assignment of portions of the AI models to the respective devices causes the machine-readable instructions to cause one or more of the at least one processor circuit to assign, to the respective ones of the pipelines, pairings of (a) one of the portions of the AI models and (b) one of the respective compute devices.

13. The at least one non-transitory machine-readable medium as defined in claim 12, wherein the change of the assignments in the first assignment data structures causes the machine-readable instructions to exchange first ones of the pairings between first and second ones of the pipelines.

14. The at least one non-transitory machine-readable medium as defined in claim 13, wherein the change of ones of the assignments in the offspring data structures causes the machine-readable instructions to change the one of the respective compute devices associated with second ones of the pairings.

15. The at least one non-transitory machine-readable medium as defined in claim 12, wherein the machine-readable instructions are to cause one or more of the at least one processor circuit to randomly assign one of the respective compute devices to the one of the portions of the AI model at a first time.

16. The at least one non-transitory machine-readable medium as defined in claim 15, wherein the machine-readable instructions are to cause one or more of the at least one processor circuit to randomly exchange a first one of the pairings between a first one of the respective pipelines and a second one of the respective pipelines at a second time.

17. The at least one non-transitory machine-readable medium as defined in claim 10, wherein the machine-readable instructions are to cause one or more of the at least one processor circuit to determine fitness scores for the first assignment data structures.

18. The at least one non-transitory machine-readable medium as defined in claim 17, wherein the machine-readable instructions are to cause one or more of the at least one processor circuit to replace the first assignment data structures with ones of the second assignment data structures based on the fitness scores.

19. An apparatus comprising:
means for pipeline generation to generate first assignment data structures to respectively assign portions of artificial intelligence (AI) models to respective compute devices for execution;
means for genetic modification to:
change the assignments in the first assignment data structures to generate offspring data structures;
change ones of the assignments in the offspring data structures; and
replace ones of the first assignment data structures with ones of the changed offspring data structures to generate second assignment data structures; and
means for scheduling to assign the portion of the AI models for execution by the compute devices based on the second assignment data structures.

20. The apparatus as defined in claim 19, wherein the means for pipeline generation is to generate respective pipelines, respective ones of the pipelines corresponding to respective ones of the AI models.
